(19) United States
(12) Patent Application Publication
(10) Pub. No.: US 2019/0114936 A1
(43) Pub. Date: Apr. 18, 2019

(54) ARTWORK VOICE MESSAGE SYSTEM

(71) Applicant: Frame Works, Inc., American Fork, UT (US)

(72) Inventor: Steevun Lemon, American Fork, UT (US)

(21) Appl. No.: 15/785,203

(22) Filed: Oct. 16, 2017

(51) Int. Cl. G09B 5/04; G09B 19/00; A47G 1/06

(52) U.S. Cl. CPC G09B 5/04; A47G 1/0616; G09B 19/0046; G09B 19/00

(57) ABSTRACT

An apparatus for delivering an audio message can include a housing mountable to a frame, a triggering mechanism incorporated into the housing, a speaker in communication with the triggering mechanism, a processor incorporated into the housing, memory in communication with the processor and containing programmed instructions to cause the processor to play an audio message stored in the memory through the speakers in response to a signal from the triggering mechanism.

### BACKGROUND

A frame is an ornamental edging around a piece of artwork, such as a painting, a photograph, a sketch, a picture, or another type of image or piece. The frame can be a decorative edging that enhances the artwork. In some ways, the frame often adds structural rigidity to the artwork, protects the artwork, defines the physical bounds of the artwork, and provides a surface to hang the artwork.

### SUMMARY

In some embodiments, an apparatus for delivering an audio message includes a housing mountable to a frame, a triggering mechanism incorporated into the housing, a processor incorporated into the housing, a speaker in communication with the processor, memory in communication with the processor and containing programmed instructions to cause the processor to play an audio message stored in the memory through the speakers in response to a signal from the triggering mechanism.

The triggering mechanism can include a tactile switch.

The tactile switch can be in physical contact with a plunger incorporated into the housing.

The apparatus can include a compressible portion of the housing. The tactile switch can be in physical communication with the compressible portion.

The triggering mechanism can include an optical sensor.

The apparatus can include a recording mechanism capable of recording the audio message.

The apparatus can include a battery incorporated into the housing where the housing includes a first side and a second side opposite the first side. The second side can be mountable to a back of the frame and a removable cover can be incorporated into the first side. The battery can be accessible through the removable cover.

In one embodiment, a system for delivering an audio message can include a frame, artwork secured to the frame, and a spacer mounted to a back of the frame. The spacer can include a housing mountable to a back of a frame, a triggering mechanism incorporated into the housing, a processor in communication with the triggering mechanism, a speaker incorporated into the housing in communication with the processor, and memory in communication with the processor containing programmed instructions to cause the processor to play an audio message stored in the memory through the speakers in response to a signal from the triggering mechanism.

The triggering mechanism can include a tactile switch.

The tactile switch can be in physical contact with a plunger incorporated into the spacer.

The system can include a compressible portion of the housing where the tactile switch is in physical communication with the compressible portion.

The triggering mechanism can include an optical sensor.

The system can include a recording mechanism capable of recording the audio message.

The system can include a battery incorporated into the housing where the housing includes a first side and a second side opposite the first side. The second side can be mountable to a back of the frame and a removable cover can be incorporated into the first side. The battery can be accessible through the removable cover.

The spacer can be mounted to a corner of the frame.

The system can include a second spacer mounted to a second corner of the frame.

The second spacer can include a triggering mechanism to activate the audio message.

In one embodiment, a method for delivering an audio message can include receiving a physical force above a predetermined threshold applied through a frame of artwork by a triggering mechanism, sending a signal, by the triggering mechanism, to a processor in response to receiving the physical force, and causing, by the processor, an audio message to be delivered through a speaker.

The triggering mechanism can be incorporated into to a spacer mounted to the back side of the frame.

The triggering mechanism can be a tactile switch.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 illustrates a cross sectional view of an example of a frame and a spacer in accordance with the present disclosure.

FIG. 2 illustrates a front view of an example of a piece of artwork in accordance with the present disclosure.

FIG. 3 illustrates a perspective view of an example of a spacer in accordance with the present disclosure.

FIG. 4 illustrates an exploded view of an example of a spacer in accordance with the present disclosure.

FIG. 5 illustrates a block diagram of an example of a message system in accordance with the present disclosure.

FIG. 6 illustrates a block diagram of an example of a method for delivering a message in accordance with the present disclosure.

FIG. 7 illustrates a cross sectional view of an example of a frame and a spacer in accordance with the present disclosure.

FIG. 8 illustrates a front view of an example of a frame and a spacer in accordance with the present disclosure.

FIG. 9 illustrates a front view of an example of a frame and a spacer in accordance with the present disclosure.

FIG. 10 illustrates a front view of an example of a frame and a spacer in accordance with the present disclosure.

FIG. 11 illustrates a front view of an example of a frame and a spacer in accordance with the present disclosure.

FIG. 12 illustrates a front view of an example of a frame and a spacer in accordance with the present disclosure.

FIG. 13 illustrates a cross sectional view of an example of a frame and a spacer in accordance with the present disclosure.

FIG. 14 illustrates a cross sectional view of an example of a frame and a spacer in accordance with the present disclosure.

FIG. 15 illustrates a cross sectional view of an example of a frame and a spacer in accordance with the present disclosure.

Throughout the drawings, identical reference numbers designate similar, but not necessarily identical, elements.

### DETAILED DESCRIPTION

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. Often, the width of an object is transverse the object's length.

The principles described in this disclosure include an apparatus, system, and method for delivering a message associated with artwork. Such artwork can be displayed in a public setting such as a museum. A triggering mechanism can be associated with the frame of the artwork. Actuation of the trigger causes a message about the artwork to be delivered. For example, the triggering mechanism can be incorporated into the frame, mounted to the frame, positioned to the side of the frame, or combinations thereof. The triggering mechanism can include a sensor that detects the presence of a user, such as an optical sensor that can detect a hand wave of a user, a gesture from a user, or a plunger sensor that can sense pressure applied to the frame of the artwork from the user, other triggering mechanisms, or combinations thereof. In some cases, a tactile switch is incorporated into a spacer that is connected to the back side of the frame. In response to pressure applied to the tactile switch from the user pressing on the frame, the tactile switch can send a signal to a processor, which the processor interprets as a command to play a message.

The message can be from the artist about the artwork, can be a historical summary of the artwork, can explain the significance of the artwork, can explain how the artwork was made, can provide other information about the artwork, or combinations thereof. The message can be stored locally or be stored in a remote location. In some cases, the speaker through which the message is delivered can be incorporated into the frame, the spacer, a location nearby the frame, or combinations thereof.

Any appropriate type of frame can be used. The frame can include a plurality of frame members that enclose an area in which the artwork is displayed. The frame members can be made of any appropriate type of material. In some cases, a non-exhaustive list of materials for the frame include wood, silver, metal, bronze, aluminum, gold, plastic, polystyrene, other types of materials, or combinations thereof. Further, the frame can have any appropriate type of color or texture.

The frame can include a first member that covers an edge of the first side of the artwork. The frame can also include a second member that covers a second edge of the artwork. The second member can be spaced apart from and aligned with the first member. The frame can also include a third member that covers a third edge of the artwork. The third member can connect the first member at its first end to the second member at its first end. The frame can also include a fourth member that covers a fourth edge of the artwork. The fourth member can connect the first member at a second end to the second member at its second end. The fourth member can be spaced apart and aligned with the third member. The first and second frame members can be transversely oriented with respect to the third and fourth members.

The first, second, third, and fourth frame members can frame the area through which the artwork can at least partially reside. In some cases, the framed area can be covered with a transparent material such as a pane of glass or plastic through which the artwork can be displayed. The pane of glass can include framing glass, acrylic glass, acrylite, plexiglas, another type of material, or combinations thereof of. In some cases, the glass can be treated with anti-reflective coatings, UV filters, other types of protective coatings or materials, or combinations thereof.

Generally, the glass is raised off the surface of the artwork. This can be done by providing a matting that separates the glass from the artwork. This spacing protects the artwork any condensation build-up inside the glass that would otherwise be absorbed into the artwork. Separating the glass from the artwork also prevents smudging the artwork when the media of the artwork includes charcoal, pastel, chalk, or other smudgeable mediums.

However, it may not be desirable to include glass in the framed area for certain kinds of artwork. For example, acrylic mediums are typically waterproof and are thus generally protected without the glass. Also, oil paint mediums are generally better off breathing. Other medium that generally may not use a pane of glass include artwork that include stained glass, tiles, and laminated posters.

The back side of the framed area can include a backing board, which can provide additional support and/or protect the artwork against dust and insects. In other examples, the frame does not include a backing board.

While the examples above have been described with frames that are generally square or rectangular, the frame can have any appropriate shape. For example, the frame can be circular, oval, triangular, asymmetric, football shaped, star shaped, heart shaped, shaped in another way, or combinations thereof.

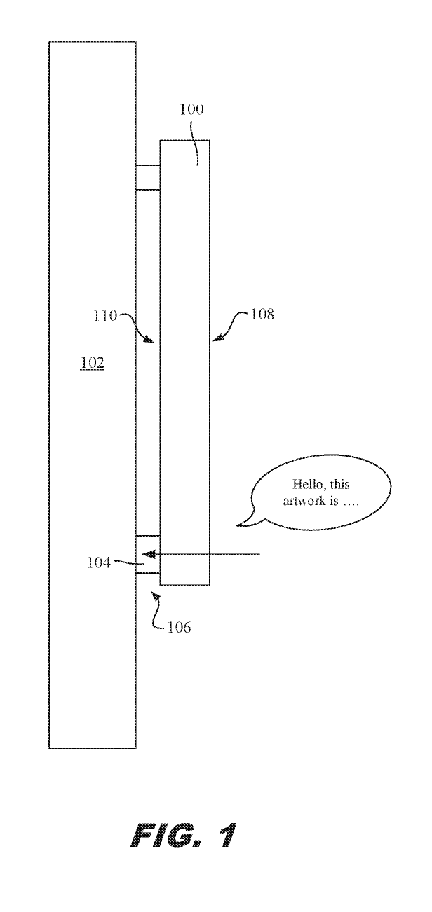

Referring now to the figures, FIG. 1 depicts an example of a frame 100 of artwork. The frame 100 is connected to a wall 102. At least one spacer 104 is placed between the frame 100 and the wall 102, which causes the frame 100 to be spaced at a distance away from the wall 102 leaving a gap 106. In this example, the frame 100 includes a front side 108 through which the user can view the artwork and a back side 110 that faces the wall 102 when the frame 100 is hung on the wall.

In this example, a user can press on the frame 100 applying a physical force on the frame, which applies a load to the spacer 104. The spacer 104 can include components that react to the load by delivering an audio message. The audio message can be about the artwork in the frame 100, about the artist, contain other types of information, or combinations thereof. Thus, a user who is viewing the artwork can press on the artwork if the user is interested in learning more about the artwork. If the user is not interested in learning more, the user does not have to press on the frame 100, thereby avoiding the delivery of the audio message.

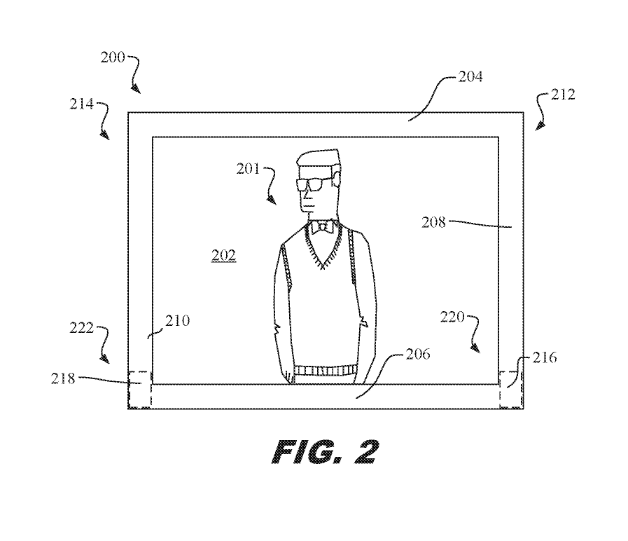

FIG. 2 depicts another example of a frame 200 with a picture 201 inside the framed area 202. In this example, the frame 200 includes a first frame member 204, a second frame member 206, a third frame member 208, and a fourth frame member 210. The first and second frame members 204, 206 can be aligned with and spaced apart from each other. The third and fourth frame members 208, 210 can be aligned with and spaced apart from each other. The third frame member 208 can connect the first ends 212 of the first and second frame members 204, 206 together. The fourth frame member 210 can connect the second ends 214 of the first and second frame members 204, 206 together.

A first spacer 216 and a second spacer 218 can be attached to a back side of the frame 200. The first spacer 216 can be mounted to the back side of the frame 200 at a first corner 220, and the second spacer 218 can be mounted to the back side of the frame 200 at a second corner 222. In some cases, just one of the first and second spacers 216, 218 incorporates a triggering mechanism that causes the audio message to be delivered in response to an applied load through the frame 200.

In other examples, both of the first and second spacers, 216, 218 include a triggering mechanism. In examples where more than one spacer includes the triggering mechanism, the spacers can be in communication with each other so that just a single spacer delivers the message. While this example depicts just two spacers connected to the back side of the frame, any appropriate number of spacers can be attached to the frame.

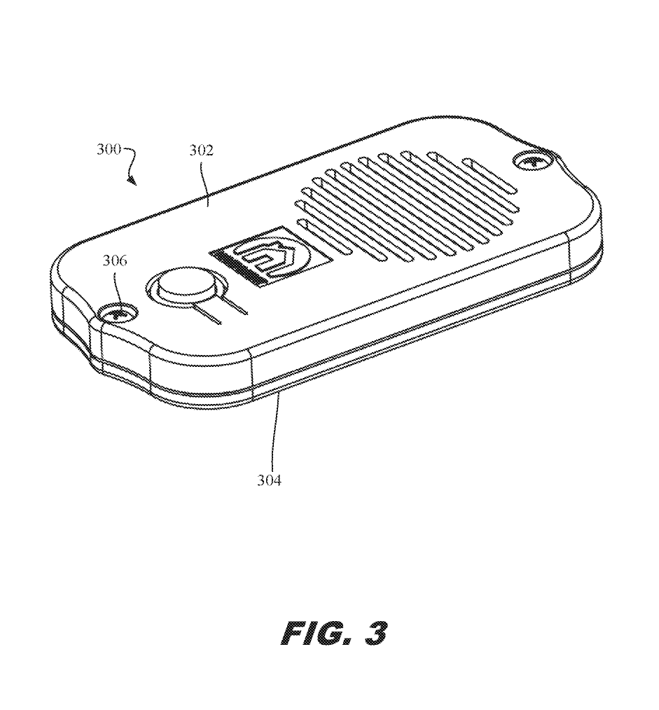

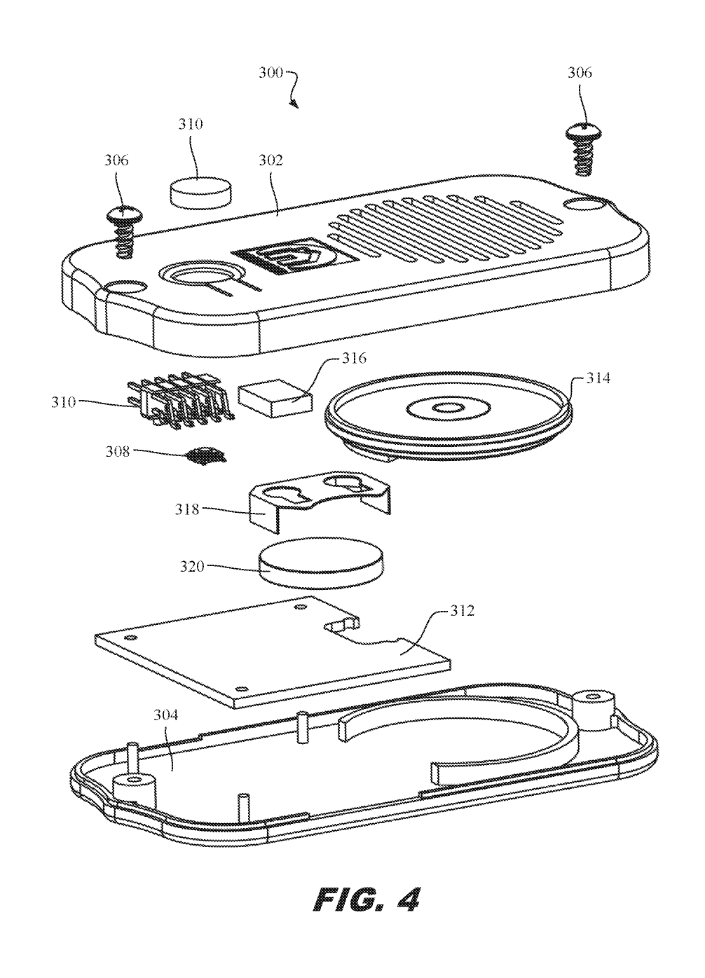

FIGS. 3 and 4 depict a spacer 300. FIG. 3 depicts a perspective view of the spacer 300, and FIG. 4 depicts an exploded view of the spacer 300. The spacer 300 can include a first side that includes a front cover 302 and a second side that includes a back cover 304. The front cover 302 and the back cover 304 can be secured together with screws 306 or another type of fastener. An internal cavity can be defined by the front cover 302 and the back cover 304 when they are joined. The back cover 304 can be mounted to the back side of the frame, and the front cover 302 can face the wall when mounted to the back side of the frame that hung on the wall.

In this example, a tactile switch 308 can be located within the internal cavity, and the tactile switch 308 can be in selective mechanical communication with a plunger 310. When the load is applied by the user through the frame, the plunger 310 can be pushed in as the gap between the wall and frame narrows. As the plunger 310 is pushed in, the plunger can apply a load to the tactile switch 308. In response, the tactile switch 308 can send a signal to a processor in the printed circuit board 312, which is also located within the internal cavity. A header 311 can be used to electrically connect different parts of the spacer 300.

A speaker 314 can also be incorporated into the spacer 300, and in response to receiving the signal from the tactile switch 308, the processor can cause the speaker 314 to deliver the message. A chip recorder 316 can be capable of recording an audio message given verbally about the artwork. In some cases, the chip recorder 316 can also store the recorded audio message.

A battery holder 318 can secure a battery 320 within the internal cavity. The battery 320 can supply power to the speaker 314, the processor, the tactile switch 308, the chip recorder 316, the memory, and other components of the spacer 300. The battery 320 can be accessible in the internal cavity when the front cover 302 is removed, which aids in quick replacement of the battery 320. The front cover 302 can be removable without dismounting the back cover 304 from the back side of the frame. This can facilitate a quicker replacement of the battery 320.

In some cases, the spacer 300 can be capable to delivering the audio message three hundred or more times with the power stored in a single battery 320. Preferably, the audio message can be delivered more than a thousand times or more on a single battery 320. In some cases, multiple batteries are incorporated into the spacer 300 to allow for delivering the audio messages more times before replacing the battery. In those cases where when the battery 320 is being replaced, the memory in the chip recorder 316 can continue to store the information in the memory without the memory being erased even when the battery is removed at least long enough to replace the battery 320. This way, the audio message does not have to be re-recorded after each battery replacement. In some cases, the audio message can be downloaded from another source so that the audio message does not have to be re-recorded in those embodiments where the memory is lost during the replacement of a battery 320. In some cases, the spacer 300 includes an alternative power source, such as a photovoltaic cell or another type of power source. In this example, no battery can be incorporated into the spacer.

In some cases, portions of the front cover 302 and back cover 304 can include soft coatings or other types of soft outer surfaces that protect the back side of the frame and/or the wall by distributing the loads coming through the frame over a greater area. The soft coatings can include rubber, felt, another type of soft material, or combinations thereof.

FIG. 5 depicts a diagram of a message system 500 incorporated into a spacer. The system 500 includes a processor 515 and memory 525. The memory 525 of the system 500 can include an audio message 545, a message player 550, and a message recorder 555. The processor 515 can also be in communication with a speaker 530, a battery 535, a recording mechanism 540, and a triggering mechanism 543.

The processor 515 can include an intelligent hardware device, (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 515 is incorporated into the printed circuit board 312 depicted in FIG. 4. In some cases, the processor 515 can be configured to operate a memory array using a memory controller. In other cases, a memory controller can be integrated into the processor 515. The processor 515 can be configured to execute computer-readable instructions stored in a memory to perform various functions (e.g., functions or tasks supporting the evaluation of prescribed optical devices).

The memory 525 can include random access memory (RAM) and read only memory (ROM). The memory 525 can store computer-readable, computer-executable software including instructions that, when executed, cause the processor to perform various functions described herein. In some cases, the memory 525 can contain, among other things, a basic input/output system (BIOS) which can control basic hardware and/or software operation such as the interaction with peripheral components or devices.

The audio message 545 can include the data structure of the audio files that can be retrieved and played in response to a command from the processor 515. The audio message 545 can be downloadable from a remote location. In other examples, the audio file is created and stored locally in the memory 525.

The message player 550 represents programmed instructions that cause the processor 715 to play the audio file in response to a signal from the triggering mechanism. In some cases, the triggering mechanism is a tactile switch, another type of switch, an optical sensor, a thermal sensor, another type of triggering mechanism, or combinations thereof. The message player 545 can cause the audio message 545 to be played over the speaker 530.

The message recorder 555 represents programmed instructions that cause the processor 515 to record the audio message 545. In some examples, the artist of the artwork, an expert, or another type of individual can record information about the artwork using the message recorder 555. In these circumstances, the person dictating the audio message can press a button or another type of input mechanism on the spacer that activates the message recorder 555. The message recorder 555 can record at least the relevant sounds produced within the environment when the user is dictating the audio message 545.

The triggering mechanism 543 can include a tactile switch. A tactile switch can be an on/off electronic switch that is only on when the plunger of the tactile switch is pressed or if there is an increased amount of force through the frame. In some cases, the tactile switch is only activated when the force is applied through the frame. When force through the frame discontinues, the switch can be automatically turned off. However, as long as the tactile switch is on for a time period sufficient to send a signal, the signal can be sent to the processor to cause the audio message to be delivered even if the user presses on the frame for just a short period of time. Thus, in some cases, the user does not have to constantly maintain a load on the frame throughout the entire duration that the audio message is delivered. The tactile switch can signal the desire of a user to hear the audio message. In some cases, the tactile switch is incorporated into a printed circuit board of the spacer.

The tactile switch can complete or break an electrical circuit on the printed circuit board or another type of electrical circuit. When the tactile switch is receiving the load, the circuit can be complete, allowing electricity to flow through the circuit to the processor. In this example, the signal is an electrical flow in the circuit. The tactile switch can include one or more electrical contacts that are bridged with the load is applied through the frame.

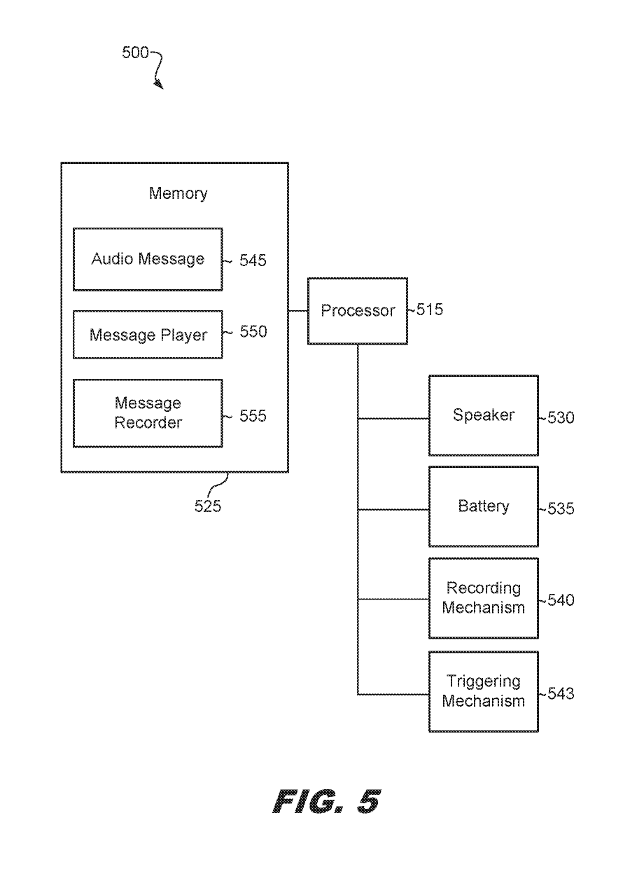

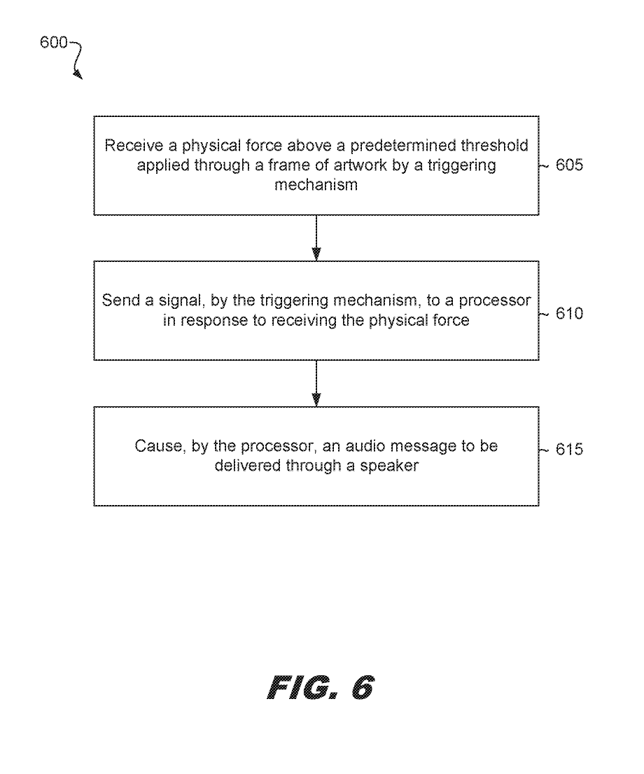

FIG. 6 illustrates an example of a method 600 of delivering the audio message. In this example, the method 600 includes receiving 605 a physical force above a predetermined threshold applied through a frame of artwork by a tactile switch; sending 610 a signal, by the tactile switch, to a processor in response to receiving the physical force; and causing 615, by the processor, an audio message to be delivered through a speaker.

At block 605, a physical force is received through the frame by the tactile switch. The tactile switch can be integrated into a spacer that is disposed between the back side of the frame and a wall supporting the frame. In some cases, the spacer is mounted to the back side of the frame. In other cases, the spacer can be mounted to the wall. The frame can be positioned such that when the force is applied to the frame, the frame imparts the load into the spacer. The spacer can compress to the point that the tactile switch is activated. In some cases, the front cover, the back cover, or another component of the spacer includes a compressible portion, such as a material that can flex under a load applied to the spacer through the frame. In some cases, the entire front cover and/or back cover are made of the compressible material. Yet, in other examples, just a section of the front cover and/or back cover are made of the compressible material. In some cases, the spacer includes a movable component, such as a plunger or another type of movable component, that moves with respected to the housing of the spacer as the load is applied to the spacer. Contact from the movable component to the tactile switch can cause the tactile switch to send a signal to the processor to activate the delivery of the audio message.

In some cases, the tactile switch has a pressure threshold that has to be achieved before the tactile switch activates the delivery of the audio message. This can prevent the unintended activation of the tactile switch in circumstances when the frame is jiggled, readjusted, brushed by, or moved in another manner. In some cases, the distance that the plunger travels to activate the tactile switch corresponds to the predetermined threshold because the force on the frame has to be sufficient to cause an end of the plunger to reach the tactile switch. In this example, if the load applied to the frame is not sufficient to cause the end of the plunger to reach the tactile switch, then the load can not reach the predetermined threshold for activating the tactile switch.

In some cases, the tactile switch can include a load cell that measures the amount of pressure applied to the tactile switch. In this type of example, the load cell can include a measurement level that has to be achieved before the tactile switch is activated.

At block 610, in response to a physical force sufficient to trigger the tactile switch, the tactile switch sends a signal to the processor to play the message. The signal can be an analog signal that results from a load that is sufficient to trigger the tactile switch.

At block 612, the processor causes the audio message to be played over the speaker. The speaker can also be incorporated into the spacer. In other examples, the speaker is in wireless communication with the processor. In this example where the speaker is in wireless communication, the processor can send the instructions to play the audio message out of the spacer to the speakers. In some cases, the speakers are incorporated into the wall, into the frame, into an object in the general area of the frame, into a headset, into other location, or combinations thereof. In some cases where the speakers are incorporated into a headset, the processor can establish a connection with the headset so that the instructions to play the audio file can be sent to the correct headset. This can be accomplished by pairing the headset to the processor when the user is within a predetermined proximity of the frame and/or processor. In some cases, the user can receive an option to pair with the processor. In other examples, the headset can automatically be paired. In other examples, the processor can cause the audio message to be delivered to all of the headsets that are within a predetermined area of the frame.

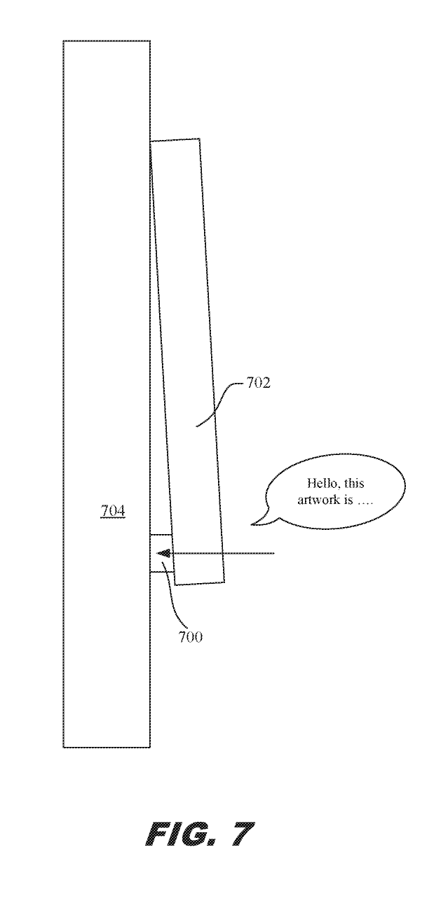

FIG. 7 depicts an example of a spacer 700 between the frame 702 and the wall 704. In this example, the spacer 700 is a single spacer that causes the frame 702 to be displaced from the wall 704 at just a portion of the frame 702.

FIGS. 8-11 depict various locations and various numbers of spacers that can be attached to the back side of the frame. Any appropriate number of spacers located at any appropriate location on the frame can be used in accordance with the principles described in the present disclosure.

FIG. 8 depicts an example of a single spacer 800 attached to a mid-region 802 of the frame 804 on the bottom frame member 806.

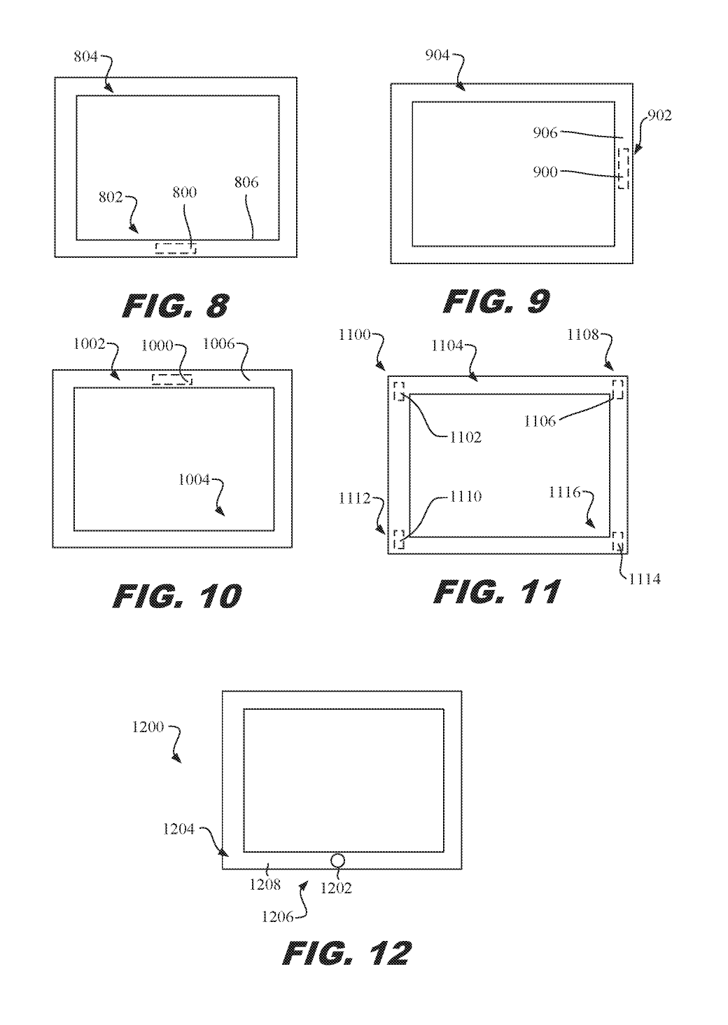

FIG. 9 depicts an example of a single spacer 900 attached to a mid-region 902 of the frame 904 on a side frame member 906.

FIG. 10 depicts an example of a single spacer 1000 attached to a mid-region 1002 of the frame 1004 on the top frame member 1006.

FIG. 11 depicts an example of a first spacer 1100 attached to a first corner 1102 of the frame 1104, a second spacer 1106 attached to a second corner 1108 of the frame 1104, a third spacer 1110 attached to a third corner 1112 of the frame 1104, and a fourth spacer 1114 attached to a fourth corner 1116 of the frame 1104.

FIG. 12 depicts an example of a trigger mechanism incorporated into the frame 1200 that includes an optical sensor 1202. In this example, the optical sensor 1202 is positioned on the front side 1204 of the frame 1200 in a mid-region 1206 of the bottom frame member 1208. The optical sensor 1202 can determine based on the proximity of a user and/or a movement performed by the user that the user desires that the audio message be delivered. For example, if the user is standing within a predetermined proximity of the frame 1200, the optical camera can cause a signal to be sent to the processor to deliver the audio message. In another example, the user has to be within the predetermined proximity of the frame 1200 for a predetermined time period before the optical sensor 1202 causes the processor to trigger the audio message. In yet another example, the user has to be in the proximity for a certain amount of time and perform an action, such as standing still and/or facing the optical sensor 1202 before triggering the audio message.

In some examples, the optical sensor 1202 includes recognition features to determine a user's facial expressions for determining when to trigger the audio message. In other examples, the recognition features allow the optical device to determine hand gestures made by the user that trigger the audio message. The optical sensor may be a photovoltaic light sensor that detects when an object casts a shadow across the sensor, resulting in a triggering event. In other examples, the optical sensor can project a beam of light towards a reflective surface, and if a user waives his or her hand in front of the optical sensor, the beam of light breaks and triggers the recitation of the audio message.

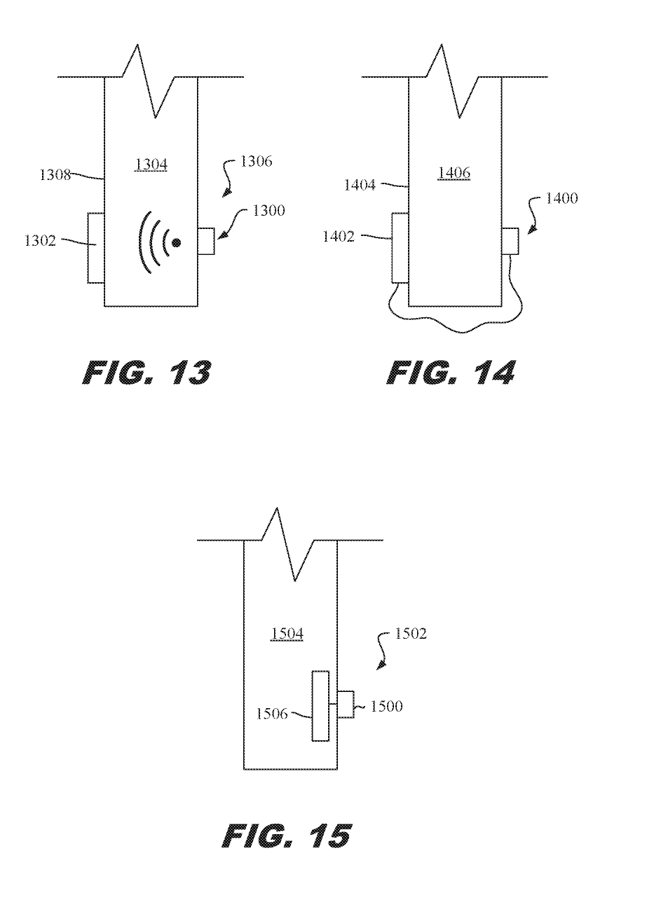

FIG. 13 depicts an example of an optical sensor 1300 in wireless communication with a spacer 1302 where the spacer 1302 is located between the frame 1304 and the wall. Thus, in this example, a portion of the audio message system is connected to a front side 1306 of the frame 1304 and a back side 1308 of the frame 1304. In other examples, the speakers, processor, and other components of the audio message system are incorporated into a device that is not connected to the frame 1304.

FIG. 14 depicts an example of an optical sensor 1400 that is hardwired to a spacer 1402 connected to the back side 1404 of the frame 1406. The spacer 1402 can include the memory for storing the message, the speaker, battery, and other components of the audio message system.

FIG. 15 depicts an example of an optical sensor 1500 exposed in the front side 1502 of the frame 1504. In the illustrated example, the other components of the audio message system are disposed within a cavity 1506 defined in the frame 1504. In this example, the optical sensor 1500 can be hardwired or in wireless communication with the other optical components.

Unless otherwise indicated, all numbers or expressions, such as those expressing dimensions, physical characteristics, etc., used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

In addition, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

We claim:

1. An apparatus for delivering an audio message, comprising:
a housing mountable to a frame;
a triggering mechanism incorporated into the housing;
a processor incorporated into the housing and in communication with the triggering mechanism;
a speaker communicatively coupled to the processor; and
memory in communication with the processor and containing programmed instructions to cause the processor to:
play the audio message stored in the memory through the speaker in response to a signal from the triggering mechanism.

2. The apparatus of claim 1, wherein the triggering mechanism includes a tactile switch.

3. The apparatus of claim 2, wherein the tactile switch is in physical contact with a plunger incorporated into the housing.

4. The apparatus of claim 2, further including a compressible portion of the housing;
wherein the tactile switch is in physical communication with the compressible portion.

5. The apparatus of claim 1, wherein the triggering mechanism includes an optical sensor.

6. The apparatus of claim 1, further including a recording mechanism capable of recording the audio message.

7. The apparatus of claim 1, further including a battery incorporated into the housing;
wherein the housing includes:
a first side;
a second side opposite the first side, the second side being mountable to a back of the frame; and
a removable cover incorporated into the first side;
wherein the battery is accessible through the removable cover.

8. A system for delivering an audio message, comprising:
a frame;
artwork secured to the frame;
a spacer mounted to a back of the frame, the spacer including:
a housing mountable to a back of the frame;
a triggering mechanism incorporated into the housing;
a processor in communication with the triggering mechanism;
a speaker communicatively coupled to the processor; and
memory in communication with the processor and containing programmed instructions to cause the processor to:
play the audio message stored in the memory through the speaker in response to a signal from the triggering mechanism.

9. The system of claim 8, wherein the triggering mechanism includes a tactile switch.

10. The system of claim 9, wherein the tactile switch is in physical contact with a plunger incorporated into the spacer.

11. The system of claim 9, further including a compressible portion of the housing;
wherein the tactile switch is in physical communication with the compressible portion.

12. The system of claim 8, wherein the triggering mechanism includes an optical sensor.

13. The system of claim 8, further including a recording mechanism capable of recording the audio message.

14. The system of claim 8, further including a battery incorporated into the housing;
wherein the housing includes:
a first side;
a second side opposite the first side, the second side being mountable to a back of the frame; and
a removable cover incorporated into the first side;
wherein the battery is accessible through the removable cover.

15. The system of claim 8, wherein the spacer is mounted to a corner of the frame.

16. The system of claim 15, further including a second spacer mounted to a second corner of the frame.

17. The system of claim 16, wherein the second spacer includes the triggering mechanism to activate the audio message.

18. A method for delivering an audio message, comprising:
receiving a physical force above a predetermined threshold applied through a frame of artwork by a triggering mechanism;
sending a signal, by the triggering mechanism, to a processor in response to receiving the physical force; and
causing, by the processor, the audio message to be delivered through a speaker.

19. The method of claim 18, wherein the triggering mechanism is incorporated into to a spacer mounted to the back side of the frame.

20. The method of claim 18, wherein the triggering mechanism is a tactile switch.
